(19) United States
(12) Patent Application Publication
(10) Pub. No.: US 2025/0004131 A1
(43) Pub. Date: Jan. 2, 2025

(54) METHODS OF PERFORMING LIGHT DETECTION AND RANGING (LIDAR) USING TIMESTAMPS ASSOCIATED WITH DATA PACKETS AND RELATED SYSTEMS

(71) Applicant: The Government of the United States of America, as represented by the Secretary of the Navy, Arlington, VA (US)

(72) Inventor: Joshua B. Beun, Alexandria, VA (US)

(73) Assignee: The Government of the United States of America, as represented by the Secretary of the Navy, Arlington, VA (US)

(21) Appl. No.: 18/214,589

(22) Filed: Jun. 27, 2023

(51) Int. Cl. G01S 17/08; G01S 7/4865

(52) U.S. Cl. CPC G01S 17/08; G01S 7/4865

(57) ABSTRACT

The present disclosure provides methods of performing light detection and ranging (LIDAR). According to some embodiments, a first data packet is generated, transmitted, and/or received to initiate transmission of a primary light signal to a remote target, and a first timestamp associated with the first data packet is generated. A second data packet is generated, received, and/or transmitted indicating reception of a reflected light signal, wherein the reflected light signal is a reflection of the primary light signal from the remote target. A second timestamp associated with the second data packet is generated, and a distance to the remote target is determined based on the first and second timestamps. Related LIDAR systems are also disclosed.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; techtran@nrl.navy.mil, referencing Navy Case #210931-US1.

### TECHNICAL FIELD

The present disclosure relates to methods of performing light detection and ranging (LIDAR) and related systems.

### BACKGROUND OF THE INVENTION

Light detection and ranging (LIDAR) is a sensing technology that is proliferating across terrestrial, maritime, airborne, and space domains, and there is growing demand in both civilian and military sectors. LIDAR, for example, may have important applications for autonomous systems (e.g., self-driving vehicles).

A LIDAR system operates by targeting an object with a laser and measuring a distance D (also referred to as a range) of the object from the LIDAR system. The LIDAR system measures the distance by measuring a period of time (ΔT, also referred to as time of flight or T_{of}) required for light to travel from the LIDAR system to the object and for a reflection of the light to return from the object to the LIDAR system. The distance can be determined as a function of the measured period of time. Stated in other words, the distance D can be calculated as a constant c times the period of time ΔT, so that D=c(ΔT/2), where c is the speed of light.

This measurement is thus based on knowledge of the time (Tₐ) that the light is emitted from the LIDAR system and the time (T_{b}) that the reflected light is sensed by the LIDAR system, so that ΔT=T_{b}−Tₐ.

Light is electromagnetic radiation, and the relevant attributes of electromagnetic radiation in a LIDAR application include amplitude, phase, frequency and polarization. LIDAR systems typically sense light using one of two methods: direct energy detection and coherent detection. Direct energy detection is incoherent meaning the LIDAR system senses changes in the amplitude of the reflected light. Coherent detection allows the recovery of the phase of the reflected light, and coherent LIDAR systems typically employ either optical homodyne or heterodyne detection.

LIDAR systems perform ranging by comparing the detected modulation (amplitude or phase) with the transmitted modulation. These signals are typically demodulated to baseband prior to comparison. The relative delay between the transmitted and detected modulation is a function of the range between the LIDAR system and the target. Therefore estimation of the range follows directly from measurement of the relative delay.

A conventional LIDAR system may include a modulator, a laser, a scanner, an optics system, a demodulator, a detector, and a receive processor. The modulator applies modulation to a transmit optical signal Tx, and may generally either modulate an amplitude or a phase of the transmit optical signal Tx. The laser amplifies the modulated optical signal and emits light (also referred to as electromagnetic radiation). The scanner steers the emitted light into the environment, and the scanner provides mechanical and/or electro-optical scanning. The optics project the light into the environment and focus received light into the optical receiver to provide a received optical signal Rx. The demodulator recovers modulation from the received optical signal Rx. The detector converts the recovered modulation (amplitude or phase) into a digital or analog signal. The receiver processor determines the distance between the LIDAR system and the target (also referred to as the range) by comparing the detected modulation of the received optical signal Rx with that of the transmit optical signal Tx to determine ΔT.

Known LIDAR systems, however, may be relatively expensive, and this expense may reduce adoption of this technology.

### SUMMARY OF THE INVENTION

This summary is intended to introduce in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

According to some embodiments of inventive concepts, a method of performing light detection and ranging (LIDAR) is disclosed. A first data packet is generated, transmitted, and/or received to initiate transmission of a primary light signal to a remote target, and a first timestamp associated with the first data packet is generated. A second data packet is generated, received, and/or transmitted indicating reception of a reflected light signal, wherein the reflected light signal is a reflection of the primary light signal from the remote target. A second timestamp associated with the second data packet is generated, and a distance to the remote target is determined based on the first and second timestamps.

In addition, a third data packet may be generated, transmitted, and/or received to initiate transmission of a reference signal over a reference signal path, and a third timestamp associated with the third data packet may be generated. A fourth data packet may be generated, received, and/or transmitted indicating reception of the reference signal over the reference signal path, and a fourth timestamp associated with the fourth data packet may be generated. In addition, the distance may be determined based on the first, second, third, and fourth timestamps.

Moreover, the primary light signal may be transmitted responsive to the first data packet, and the reflected light signal may be received. The reference signal may be transmitted over the reference signal path responsive to the third data packet, and the reference signal may be received over the reference signal path.

The first timestamp may be generated using a first clock, the second timestamp may be generated using a second clock, the third timestamp may be generated using the second clock, the fourth timestamp may be generated using the first clock, and the first and second clocks may be independent of each other. More particularly, the first clock may operate based on a first oscillator, the second clock may operate based on a second oscillator, and the first and second oscillators may be different oscillators.

The distance to the remote target may be determined based on a difference between times associated with the second and first timestamps and a difference between times associated with the fourth and third timestamps.

The distance to the remote target may be further based on a delay of the reference signal path, wherein the delay of the reference signal path is determined prior to generating the third data packet.

The first, second, third, and fourth data packets may be first, second, third, and fourth Ethernet data packets.

According to some embodiments, the first and second timestamps may be generated respectively using first and second clocks that are independent of each other and the third and fourth timestamps may be generated respectively using the second and first clocks. According to some other embodiments, the first and second timestamps may be generated respectively using the first and second clocks that are independent of each other and the third and fourth timestamps may be generated respectively using the first and second clocks.

The first and second data packets may be first and second Ethernet data packets. Moreover, the primary light signal may be transmitted responsive to the first data packet, the reflected light signal may be received, and the second data packet may be generated, transmitted, and/or received responsive to receiving the reflected light signal. In addition, the primary light signal may be a primary laser signal that is transmitted to the remote target, and the reflected light signal may be a reflection of the primary laser signal that is reflected from the remote target.

According to some other embodiments of inventive concepts, a light detection and ranging (LIDAR) system may be provided. The LIDAR system includes an optical system and a host computer coupled with the optical system. The optical system is configured to transmit a primary light signal to a remote target in response to a first data packet, to receive a reflected light signal, and to generate a second data packet in response to receiving the reflected light signal. Moreover, the reflected light signal is a reflection of the primary light signal from the remote target. The host computer is configured to generate the first data packet to initiate transmission of the primary light signal to the remote target, to generate a first timestamp associated with the first data packet, to receive the second data packet from the optical system indicating reception of the reflected light signal from the remote target, to generate a second timestamp associated with the second data packet, and to determine a distance to the remote target based on the first and second timestamps.

In addition, the optical system may define a reference signal path, and the optical system may be further configured to transmit a reference signal over the reference signal path in response to a third data packet, to receive the reference signal over the reference signal path, and to generate a fourth data packet responsive to receiving the reference signal over the reference signal path. The host computer may be configured to generate the third data packet to initiate transmission of the reference signal over the reference signal path, to generate a third timestamp associated with the third data packet, to receive the fourth data packet indicating reception of the reference signal over the reference signal path, to generate a fourth timestamp associated with the fourth data packet, and to determine the distance to the remote target based on the first, second, third, and fourth timestamps.

The host computer may include first and second clocks that are independent of each other, and the host computer may be configured to generate the first timestamp based on the first clock, to generate the second timestamp based on the second clock, to generate the third timestamp based on the second clock, and to generate the fourth timestamp based on the first clock. Moreover, the first clock may operate based on a first oscillator, the second clock may operate based on a second oscillator, and the first and second oscillators may be different oscillators.

The host computer may be configured to determine the distance to the remote target based on a difference between times associated with the second and first timestamps and a difference between times associated with the fourth and third timestamps.

The host computer may be configured to determine the distance to the remote target based on the first, second, third, and fourth timestamps, and based on a delay of the reference signal path, wherein the delay of the reference signal path is determined prior to transmitting the third data packet.

The first, second, third, and fourth data packets may be first, second, third, and fourth Ethernet data packets.

The host computer may include a first network interface device having a first clock and a second network interface device having a second clock, and the first and second clocks may operate independently. The first network interface device may be configured to transmit the first data packet and to generate the first timestamp based on the first clock. The second network interface device may be configured to receive the second data packet and to generate the second timestamp based on the second clock. The second network interface device may be configured to transmit the third data packet and to generate the third timestamp based on the second clock. The first network interface device may be configured to receive the fourth data packet and to generate the fourth timestamp based on the first clock.

The optical system may include the reference signal path, a first optical transceiver having a first optical transmitter and a first optical receiver, a second optical transceiver having a second optical transmitter and a second optical receiver, and an optical assembly. The reference signal may be a reference light signal, and the reference signal path may be an optical reference signal path. The first optical transmitter may be configured to transmit the primary light signal responsive to the first data packet being received at the first optical transceiver. The optical assembly may be configured to direct the primary light signal to the remote target. The first optical receiver may be configured to receive the reference light signal over the reference signal path. The first optical transceiver may be configured to generate the fourth data packet responsive to receiving the reference light signal at the first optical receiver. The second optical transmitter may be configured to transmit the reference light signal over the optical reference signal path responsive to the third data packet being received at the second optical transceiver. The optical assembly may be configured to direct the reflected light signal to the second optical receiver. The second optical receiver may be configured to receive the reflected light signal. The second optical transceiver may be configured to generate the second data packet responsive to receiving the reflected light signal at the second optical receiver.

The host computer may include a first network interface device having a first clock and a second network interface device having a second clock, and the first and second clocks may operate independently. The host computer may be configured to transmit the first data packet from the first network interface device to the first optical transceiver. The first network interface device may be configured to generate the first timestamp based on the first clock. The host computer may be configured to receive the second data packet at the second network interface device from the second optical transceiver. The second network interface device may be configured to generate the second timestamp based on the second clock. The host computer may be configured to transmit the third data packet from the second network interface device to the second optical transceiver. The second network interface device may be configured to generate the third timestamp based on the second clock. The host computer may be configured to receive the fourth data packet at the first network interface device from the first optical transceiver. The first network interface device may be configured to generate the fourth timestamp based on the first clock.

According to some embodiments, the first and second timestamps may be generated respectively using first and second clocks that are independent of each other, and the third and fourth timestamps may be generated respectively using the second and first clocks. According to some other embodiments, the first and second timestamps may be generated respectively using the first and second clocks that are independent of each other, and the third and fourth timestamps may be generated respectively using the first and second clocks.

The first and second data packets may be first and second Ethernet data packets. Moreover, the primary light signal may be a primary laser signal that is transmitted to the remote target, and the reflected light signal may be a reflection of the primary laser signal that is reflected from the remote target.

According to still other embodiments of inventive concepts, a method of performing light detection and ranging (LIDAR) is provided. A first data packet is generated to initiate transmission of a primary light signal to a remote target, and a first timestamp associated with the first data packet is generated. The primary light signal is transmitted to the remote target responsive to the first data packet, and a reflected light signal that is a reflection of the primary light signal is received from the remote target. A second data packet is generated responsive to receiving the reflected light signal, and a second timestamp associated with the second data packet is generated. A third data packet is generated to initiate transmission of a reference signal over a reference signal path, and a third timestamp associated with the third data packet is generated. A reference signal is transmitted over a reference signal path responsive to the third data packet, and the reference signal is received over the reference signal path. A fourth data packet is generated responsive to receiving the reference signal over the reference signal path, and a fourth timestamp associated with the fourth data packet is generated. A distance to the remote target is determined based on the first, second, third, and fourth timestamps.

According to some embodiments, the first and fourth timestamps may be generated based on a first clock, the second and third timestamps may be generated based on a second clock, and the first and second clocks may be independent of each other. According to some other embodiments, the first and third timestamps may be generated based on a first clock, the second and fourth timestamps may be generated based on a second clock, and the first and second clocks may be independent of each other.

### BRIEF DESCRIPTION OF DRAWINGS

Examples of embodiments of inventive concepts may be more clearly understood from the following detailed description taken in conjunction with the accompanying drawings in which:

FIG. 1 provides a block diagram illustrating light detection and ranging (LIDAR) systems according to some embodiments of inventive concepts;

FIG. 2 provides a flow diagram illustrating operations of LIDAR systems of FIG. 1 according to some embodiments of inventive concepts;

FIG. 3 provides a block diagram illustrating LIDAR systems according to some embodiments of inventive concepts; and

FIGS. 4A and 4B provide a flow diagram illustrating operations of LIDAR systems of FIG. 3 according to some embodiments of inventive concepts.

### DETAILED DESCRIPTION OF THE INVENTION

Aspects and features of the present disclosure will now be described more fully with reference to the accompanying drawings. The following description shows, by way of example, combinations and configurations in which aspects, features, and embodiments of inventive concepts can be put into practice. It will be understood that the disclosed aspects, features, and/or embodiments are merely examples, and that one skilled in the art may use other aspects, features, and/or embodiments or make functional and/or structural modifications without departing from the scope of the present disclosure. Moreover, like reference numerals refer to like elements throughout.

According to some embodiments of inventive concepts, a network data communication protocol (e.g., the Ethernet communication protocol), which may be wired or wireless, is used to perform distance measurements (also known as range measurements) in a LIDAR (Light Detection and Ranging) system. More particularly, data packets of the network data communication protocol (e.g., Ethernet data packets of the Ethernet communication protocol) may be used to trigger optical signal modulation/demodulation, and distance/range measurements may be determined based on timestamps associated with the data packets. By using a technology such as Ethernet according to some embodiments disclosed herein, more expensive dedicated electro-optical hardware may be omitted/replaced. This may reduce cost and/or complexity relative to custom electo-optical components used in conventional LIDAR systems.

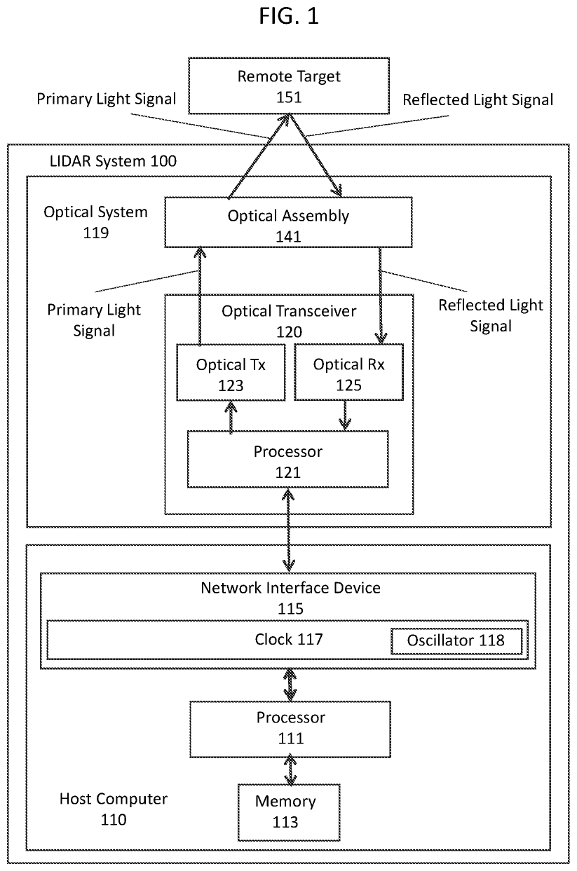

FIG. 1 is a block diagram illustrating LIDAR system 100 according to some embodiments of inventive concepts. As shown in FIG. 1, LIDAR system 100 includes host computer 110 and optical system 119. Moreover, optical system 119 includes optical transceiver 120 and optical assembly 141.

Host computer 110 includes processor 111 (also referred to as processing circuitry), memory 113 (also referred to as memory circuitry), and network interface device 115 (e.g., a network interface card or NIC, network interface controller, network adapter, local area network adapter, etc.). The network interface device 115 is configured to transmit and receive data packets according to a network data communication protocol such as the Ethernet communication protocol. Moreover, network interface device 115 includes clock 117 that is used to generate timestamps for data packets transmitted from and received by network interface device 115, and clock 117 includes oscillator 118. Accordingly, clock 117 operates based on oscillator 118. For example, clock 117 may include a counter that generates a clock output based on an oscillator signal from oscillator 118.

Processor 111 is coupled with memory 113, and memory 113 may include computer readable program code that when executed by the processor 111 causes the processor to perform operations according to embodiments disclosed herein. Accordingly, processor 111 may execute computer readable program code of memory 113 to perform operations and/or to control NID 115 as disclosed herein. According to other embodiments, processor 111 may be defined to include memory so that separate memory is not required.

Optical transceiver 120 includes processor 121 coupled with network interface device 115, optical transmitter (Tx) 123 coupled with processor 121, and optical receiver (Rx) 125 coupled with processor 121. Optical assembly 141 is coupled with optical transmitter 123 and optical receiver 125 to direct a primary light signal from optical transmitter 123 toward remote target 151 and to direct a reflected light signal (i.e., a reflection of the primary light signal from the target) from remote target 151 to optical receiver 125. Remote target 151 is remote from LIDAR system 100, and remote target 151 is not an element of LIDAR system 100.

Processor 121 may include memory with computer readable program code that when executed by the processor causes processor 121 to perform operations according to embodiments disclosed herein. Accordingly, processor 121 may execute computer readable program code to perform operations, to control optical transceiver 120, and/or to communicate with host computer 110 as disclosed herein. According to other embodiments, optical transceiver 120 may include memory separate from processor 121. Processor 121 may also include a network interface to facilitate communication with host computer 110 and/or optical transceiver 120 may include a separate network interface device between processor 121 and NID 115.

In LIDAR system 100, processor 111 initiates a LIDAR measurement of a distance (also referred to as a range) to remote target 151, and then, processor 111 determines the distance to remote target 151 based on timestamps. In particular, processor 111 causes network interface device (NID) 115 to generate a first data packet to initiate transmission of a primary light signal to remote target 151, and NID 115 transmits the first data packet to processor 121 of optical transceiver 120. NID 115 also generates a first timestamp associated with the first data packet and/or associated with a time T₁ when the first data packet is generated by and/or transmitted from NID 115. Processor 111 stores the first timestamp in memory 113. More particularly, NID 115 generates the first timestamp using clock 117, where clock 117 operates based on oscillator 118. For example, the first timestamp may be generated based on transmission of the first data packet, and the first data packet and the first time stamp may be generated in accordance with the network data communication protocol (e.g., the Ethernet communication protocol).

In response to receiving the first data packet, processor 121 triggers optical transmitter 123 to transmit the primary light signal through optical assembly 141 to remote target 151. More particularly, optical assembly 141 is configured to direct the primary light signal to remote target 151 (also referred to as steering the primary light signal), and to direct a reflection of the primary light signal (a reflected light signal) from remote target 151 to optical receiver 125 (also referred to as steering the reflected light signal). In response to receiving the reflected light signal at optical receiver 125, optical receiver 125 triggers processor 121 to transmit a second data packet to NID 115 where the second data packet indicates reception of the reflected light signal.

In response to receiving the second data packet (indicating reception of the reflected light signal), NID 115 is configured to generate a second timestamp associated with the second data packet and associated with a time T₂ when the second data packet is received at NID 115. Accordingly, the second timestamp (associated with time T₂) is generated responsive to reception of the second data packet, and the second timestamp is generated using clock 117 (where clock 117 operates based on oscillator 118), and processor 111 stores the second timestamp in memory 113. For example, the second timestamp may be generated based on reception of the second data packet at NID 115, and the second data packet and the second time stamp may be generated in accordance with the network data communication protocol (e.g., the Ethernet communication protocol).

Processor 111 then determines the distance to remote target 151 (also referred to as range) based on the first and second timestamps associated with times T₁ and T₂. In particular, a time of flight (T_{of}) may be defined as the period of time from transmission of the primary light signal from optical transmitter 123 to reception of the reflected light signal at optical receiver 125. Accordingly, the distance (D) to remote target 151 may be determined (in Equation 1) as a function of time of flight T_{of} and the speed of light c, such that:

$$D = c ( {T}_{of )} / 2. \qquad ( Equation 1 )$$

Moreover, T_{of} may be approximated (in Equation 2) as a difference between the first and second times (T₂−T₁) based on respective first and second timestamps, such that:

$$D = c ( {T}_{2} - {T}_{1} ) / 2. \qquad ( Equation 2 )$$

The use of times T₁ and T₂ to approximate the time of flight T_{of}, however, may introduce error due to delay between generation of the first timestamp (associated with time T₁) and actual transmission of primary light signal from optical transmitter 123 and/or due to delay between actual reception of reflected light signal at optical receiver 125 and generation of the second timestamp (associated with time T₂). Accordingly, the distance determination may be improved (in Equation 3) by introducing a constant k to reflect these delays, such that:

$$D = c ( {T}_{2} - {T}_{1} - k ) / 2 . \qquad ( Equation 3 )$$

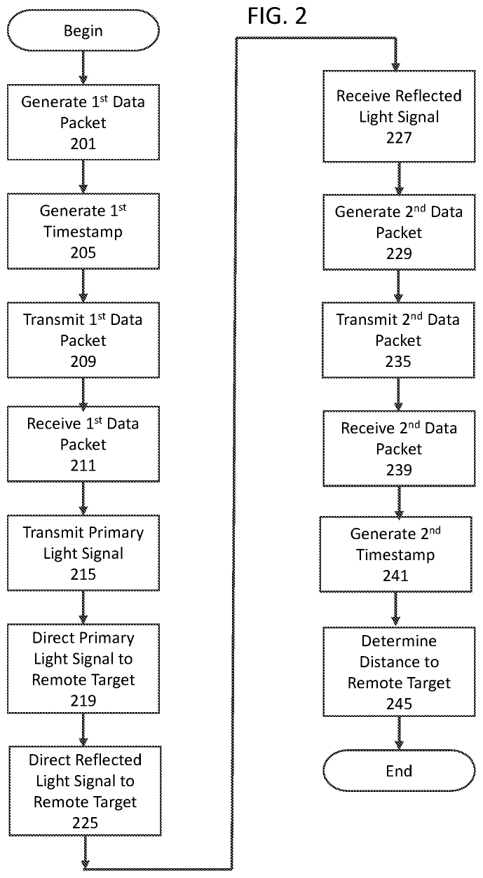

FIG. 2 provides a flow chart illustrating operations of LIDAR system 100 of FIG. 1 according to some embodiments of inventive concepts. At block 201, host computer 110 generates a first data packet to initiate transmission of a primary light signal to remote target 151 (e.g., NID 115 of host computer generates the first data packet). At block 205, host computer 110 generates a first timestamp associated the first data packet and associated with time T₁ when the first data packet is generated/transmitted (e.g., NID 115 generates the first timestamp). At block 209, host computer 110 transmits the first data packet to optical transceiver 120 (e.g., NID 115 transmits the first data packet). As discussed above, the first data packet may be generated/transmitted and the first timestamp may be generated in accordance with a network data communication protocol (e.g., the Ethernet communication protocol), and the first timestamp may be generated using clock 117 based on oscillator 118.

At block 211, optical transceiver 120 receives the first data packet (e.g., processor 121 of optical transceiver 120 receives the first data packet). At block 215, optical transceiver 120 transmits the primary light signal (e.g., the optical transmitter 123 transmits the primary light signal) responsive to the first data packet being received at optical transceiver 120. As discussed above, the primary light signal may be a primary laser signal. At block 219, optical assembly 141 directs the primary light signal from optical transceiver 120 to remote target 151 (also referred to as steering the primary light signal), and at block 225, optical assembly 141 directs the reflected light signal (i.e., a reflection of the primary light signal from remote target 151) to optical transceiver 120 (e.g., to optical receiver 125).

At block 227, optical transceiver 120 receives the reflected light signal (e.g., optical receiver 125 receives the reflected light signal), and at block 229, optical transceiver 120 generates the second data packet responsive to receiving the reflected light signal (e.g., optical receiver 125 triggers processor 121 to generate the second data packet). Accordingly, the second data packet indicates reception of the reflected light signal. At block 235, optical transceiver 120 transmits the second data packet to host computer 110 (e.g., processor 121 transmits the second data packet to NID 115). At block 239, host computer 110 receives the second data packet (e.g., NID 115 of host computer 110 receives the second data packet), and at block 241, host computer 110 generates the second timestamp associated with the second data packet and associated with time T₂ when the second data packet is generated/received (e.g., NID 115 of host computer 110 generates the second timestamp responsive to receiving the second data packet).

At block 245, host computer determines the distance to remote target 151 based on the first and second timestamps associated with times T₁ and T₂ (e.g., processor 111 determines the distance). As discussed above, the distance may be determined based on one of the following equations:

$$D = c ( {T}_{2} - {T}_{1} ) / 2 , or \qquad ( Equation 2 )$$

$$D = c ( {T}_{2} - {T}_{1} - k ) / 2 . \qquad ( Equation 3 )$$

While these equations are given by way of example, other equations and/or formulas may be used.

In embodiments of FIGS. 1 and 2, clock 117 is thus used to measure the delay between transmission of the primary light signal and the reflected light signal based on the first and second timestamps associated with times T₁ and T₂ (i.e., delay=T₂ minus T₁), and this delay is used to determine the distance to the target. Because clock 117 operates based on oscillator 118, the delay is effectively being measured using oscillator 118.

As used herein, each timestamp is associated with a respective time T (e.g., T₁ and T₂) and with a respective data packet. According to some embodiments, a timestamp may be used directly as the respective time T for distance calculations. According to some other embodiments, a timestamp may be used to derive the respective time T for distance calculations. Moreover, each timestamp may be a hardware timestamp that is generated by the respective NID.

According to some embodiments of inventive concepts, host computer 110 and/or elements thereof may be implemented using a commercial off the shelf COTS single board computer SBC (e.g., an Arduino based SBC). For example, NID 115 may be provided as a COTS network interface card NIC according to the Ethernet communication protocol. Moreover, processor 121 of optical transceiver 120 may be implemented using a commercial off the shelf (COTS) media converter/transceiver between NID 115 and optical transmitter/receiver 123/125.

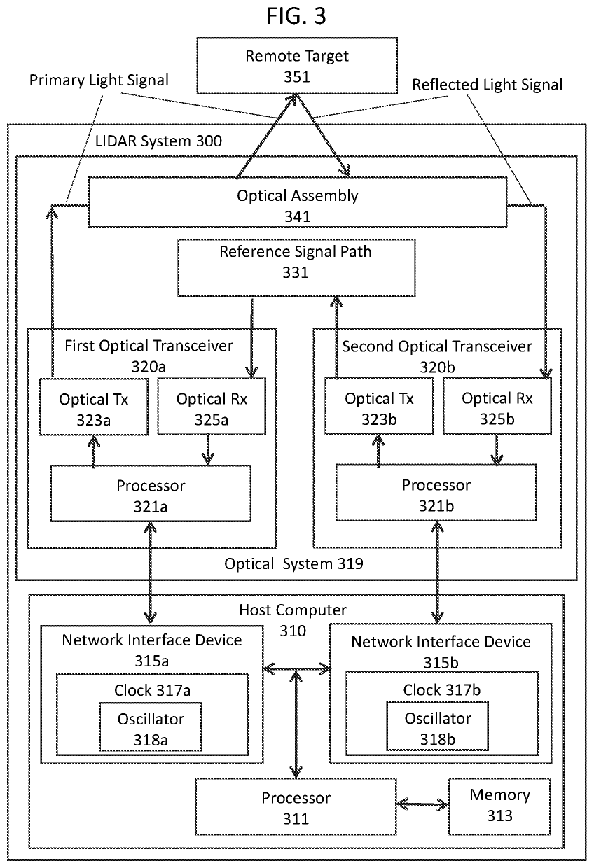

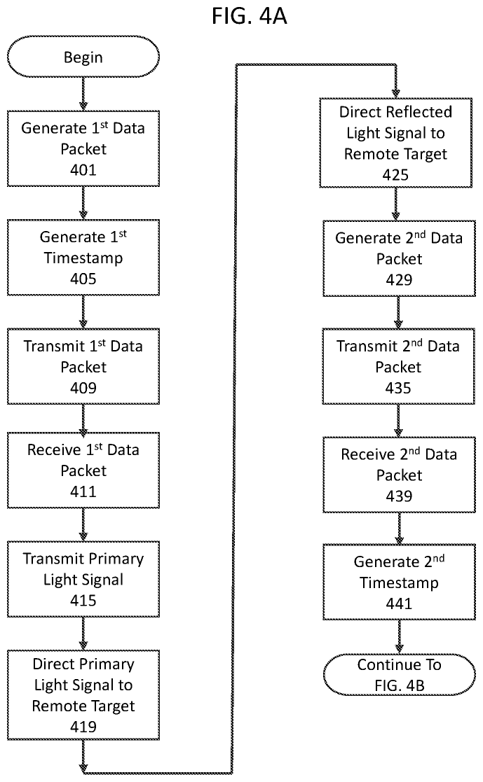

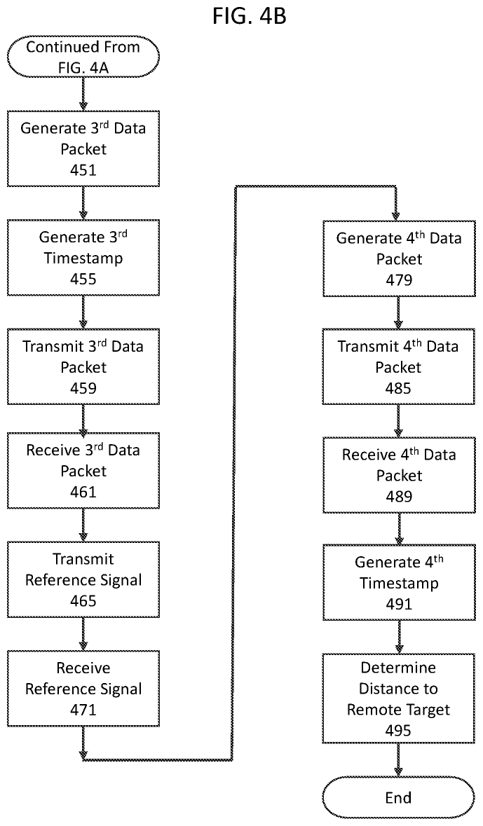

In embodiments discussed below with respect to FIGS. 3-4, an accuracy of the timestamp based measurement may be improved by adding a reference signal path and using two clocks/oscillators to measure the delay. Moreover, time-frequency-transfer TFT correction may be used to improve/correct measurements based on two clocks/oscillators.

FIG. 3 is a block diagram illustrating a LIDAR system 300 according to additional embodiments of inventive concepts. As shown in FIG. 3, LIDAR system 300 includes host computer 310 and optical system 319. Moreover, optical system 319 includes optical transceivers 320a and 320b, reference signal path 331, and optical assembly 341.

Host computer 310 includes processor 311, memory 313, and network interface devices 315a and 315b (e.g., network interface cards or NICs, network interface controllers, network adapters, local area network adapters, etc.). The network interface devices 315a and 315b are configured to transmit and receive data packets according to a network data communication protocol (e.g., the Ethernet communication protocol). Moreover, each of network interface devices 315a and 315b may include a respective clock 317a and 317b that is used to generate timestamps for data packets transmitted from and/or received by the respective network interface device, and each clock includes a respective oscillator 318a and 318b. Accordingly, clocks 317a and 317b operate independently of each other meaning that each clock operates based on a different oscillator. For example, clock 317a may include a first counter that generates a clock output based on a first oscillator signal from oscillator 318a, and clock 317b may include a second counter that generates a clock based on a second oscillator signal from oscillator 318b.

Processor 311 is coupled with memory 313, and memory 313 may include computer readable program code that when executed by the processor 311 causes processor 311 to perform operations according to embodiments disclosed herein. Accordingly, processor 311 may execute computer readable program code of memory 313 to perform operations and/or to control NIDs 315a and/or 315b as disclosed herein. According to other embodiments, processor 311 may be defined to include memory so that separate memory is not required.

Optical transceiver 320a includes processor 321a coupled with network interface device 315a, optical transmitter (Tx) 323a coupled with processor 321a, and optical receiver (Rx) 325a coupled with processor 325a. Similarly, optical transceiver 320b includes processor 321b coupled with network interface device 315b, optical transmitter (Tx) 323b coupled with processor 321b, and optical receiver (Rx) 325b coupled with processor 325b. Moreover, optical transmitter 323b is coupled with optical receiver 325a through reference signal path 331 (e.g., an optical reference signal path). Reference signal path 331, for example, may include one or more of an optical fiber and/or an optical attenuator (e.g., a 25 dB optical attenuator) with a known delay for an optical signal passing through reference signal path 331. Reference signal path 331 thus defines a fixed path between optical transmitter 323b of optical transceiver 320b and optical receiver 325a of optical transceiver 320a.

Each of processors 321a/321b may include memory with computer readable program code that when executed by the processor causes the processor to perform operations according to embodiments disclosed herein. Accordingly, each of processors 321a/321b may execute computer readable program code to perform operations to control optical transceiver 320a/320b and/or communicate with host computer 310 as disclosed herein. According to other embodiments, optical transceivers 320a/320b may include memory separate from processors 321a/321b. Each of processors 321a/321b may also include a network interface to facilitate communication with host computer 110 and/or each of optical transceivers 320a/320b may include a separate network interface device between processor 321a/321b and NID 315a/315b.

Optical assembly 341 is coupled with optical transmitter 323a of optical transceiver 320a and optical receiver 325b of optical transceiver 320b to direct a primary light signal (e.g., a primary laser signal) from optical transmitter 323a toward remote target 351 and to direct a reflected light signal from remote target 351 (i.e., a reflection of the primary light signal from the remote target) to optical receiver 325b. Remote target 351 is remote from LIDAR system 300, and remote target 351 is not an element of LIDAR system 300.

According to some embodiments of inventive concepts, host computer 210 and/or elements thereof may be implemented using a commercial off the shelf COTS single board computer SBC (e.g., an Arduino based SBC). For example, NIDs 315a and 315b may be provided as COTS network interface cards NICs according to the Ethernet communication protocol. Moreover, processor 321a of optical transceiver 320a and processor 321b of optical transceiver 320b may each be implemented using a commercial off the shelf (COTS) media converter/transceiver between the respective NID and optical transmitter/receiver.

In LIDAR system 300, processor 311 initiates a LIDAR measurement of a distance to remote target 351 (also referred to as a range), and then, processor 311 determines the distance to remote target 351 based on timestamps. In particular, processor 311 causes network interface device (NID) 315a to generate a first data packet to initiate transmission of a primary light signal to remote target 351, and NID 315 transmits the first data packet to processor 321a of optical transceiver 320a. NID 315a also generates a first timestamp associated with the first data packet and associated with a time T₁ when the first data packet is generated by and/or transmitted from NID 315a, and processor 311 stores the first timestamp in memory 313. More particularly, NID 315a generates the first timestamp using clock 317a, where clock 317a operates based on oscillator 318a. For example, the first timestamp may be generated based on transmission of the first data packet, and the first data packet and the first time stamp may be generated in accordance with the network data communication protocol (e.g., the Ethernet communication protocol).

In response to receiving the first data packet, processor 321a triggers optical transmitter 323a to transmit the primary light signal through optical assembly 341 to remote target 351. More particularly, optical assembly 341 is configured to direct the primary light signal (e.g., a primary laser signal) from optical transmitter 323a to remote target 351 (also referred to as steering the primary light signal), and to direct a reflection of the primary light signal (also referred to as a reflected light signal) from remote target 351 to optical receiver 325b (also referred to as steering the reflected light signal). In response to receiving the reflected light signal at optical receiver 325b of optical transceiver 325b, optical receiver 325b triggers processor 321b of optical transceiver 325b to transmit a second data packet to NID 315b where the second data packet indicates reception of the reflected light signal.

In response to receiving the second data packet (indicating reception of the reflected light signal), NID 315b is configured to generate a second timestamp associated with the second data packet and associated with a time T₂ when the second data packet is transmitted by processor 321b and/or received at NID 315b. Accordingly, the second timestamp may be generated responsive to reception of the second data packet at NID 315b. The second timestamp is generated using clock 317b (where clock 317b operates based on oscillator 318b), and processor 311 stores the second timestamp in memory 313. For example, the second timestamp may be generated based on reception of the second data packet at NID 315a, and the second data packet and the second time stamp may be generated in accordance with the network data communication protocol (e.g., the Ethernet communication protocol). Accordingly, first and second timestamps (associated with times T₁ and T₂) are generated using different clocks 317a and 317b that are independent of each other, meaning that the different clocks operate based on different oscillators 318a and 318b.

In addition, processor 311 causes network interface device (NID) 315b to generate a third data packet to initiate transmission of a reference signal (e.g., a reference light signal) over reference signal path 331, and NID 315b transmits the third data packet to processor 321b of optical transceiver 320b. NID 315b also generates a third timestamp associated with the third data packet and associated with time T₃ when the third data packet generated by and/or transmitted from NID 315b, and processor 311 stores the third timestamp in memory 313. More particularly, NID 315b generates the third timestamp using clock 317b, where clock 317b operates based on oscillator 318b. For example, the third timestamp may be generated based on transmission of the third data packet, and the third data packet and the third timestamp may be generated in accordance with the network data communication protocol (e.g., the Ethernet communication protocol).

In response to receiving the third data packet, processor 321b of optical transceiver 320b triggers optical transmitter 323b of optical transceiver 320b to transmit the reference signal (e.g., a reference light/laser signal) through reference signal path 331 to optical receiver 325a of optical transceiver 320a. More particularly, reference signal path 331 may define a fixed path from optical transmitter 323b to optical receiver 325a with a fixed/known delay for the reference signal. For example, the reference signal may be an optical reference signal (e.g., a laser signal), and the reference signal path may include an optical fiber and/or an optical attenuator (e.g., a 25 dB optical attenuator). In response to receiving the reference signal at optical receiver 325a of optical transceiver 320a, optical receiver 325a triggers processor 321a to transmit a fourth data packet to NID 315a where the fourth data packet indicates reception of the reference signal. According to some other embodiments, reference signal path 331 may be provided for a reference signal other than an optical reference signal. For example, reference signal path 331 may be an electrical reference signal path (e.g., an electrical conductor) having a fixed/know delay for an electrical reference signal, transmitter 323b may be an electrical signal transmitter, and receiver 325a may be an electrical signal receiver.

In response to receiving the fourth data packet (indicating reception of the reference signal), NID 315a is configured to generate a fourth timestamp associated with the second data packet. Accordingly, the fourth timestamp is associated with the fourth data packet and with a time T₄ when the fourth data packet is generated/transmitted by processor 321a and/or received at NID 318a, the fourth data packet is generated responsive to reception of the fourth data packet, and the fourth timestamp is generated using clock 317a (where clock 317a operates based on oscillator 318a), and processor 311 stores the fourth timestamp in memory 313. For example, the fourth timestamp may be generated based on reception of the fourth data packet at NID 315a, and the fourth data packet and the fourth time stamp may be generated in accordance with the network data communication protocol (e.g., the Ethernet communication protocol). Accordingly, timestamps associated with times T₃ and T₄ are generated using different clocks 317b and 317a that are independent of each other, meaning that the different clocks operate based on different oscillators 318b and 318a.

Processor 311 then determines the distance to remote target 351 (also referred to as range) based on the first, second, third and fourth timestamps that are associated with times T₁, T₂, T₃, and T₄, and based on a fixed/known delay T_{rf} through the reference signal path. The known delay T_{rf} through the reference signal path 331 may be determined, for example, by calibration before transmitting any of the first, second, third, and fourth data packets. In embodiments of FIG. 3, the time of flight T_{of} may be determined as follows:

$${T}_{of} = [ {T}_{2} - {T}_{1} ] - [ ( {T}_{4} - {T}_{3} ) - {T}_{rf} ] . \qquad ( Equation 4 )$$

Accordingly, the distance D from LIDAR system 300 to remote target 351 (also referred to as range) may be determined as follows (using T_{of} as provided in Equation 4):

$$D = c ( {T}_{of )} / 2. \qquad ( Equation 5 )$$

In the formula for time of flight T_{of} provided above in Equation 4, the expression [T₂−T₁] may represent a raw value of the time of flight for the primary and reflected light signals plus signaling delay (i.e., the time between generating the first timestamp and transmission of the primary light signal plus the time between receiving the reflected light signal and generating the second time stamp). In addition, the expression [(T₄−T₃)−T_{rf}] may represent a correction to remove the signaling delay and/or to compensate for inaccuracies of oscillators 318a and 318b. Accordingly, the formulas for T_{of} and D in Equations 4 and 5 can be used together with the structure of FIG. 3 to provide improved distance measurements based on NID clocks 317a and 317b.

As used herein, each timestamp is associated with a respective time T (e.g., T₁, T₂, T₃, and T₄) and with a respective data packet. According to some embodiments, a timestamp may be used directly as the respective time T for distance calculations. According to some other embodiments, a timestamp may be used to derive the respective time T for distance calculations. In addition, no ordering of the third and fourth data packets, times, and timestamps relative to the first and second data packets, times, and timestamps is implied by the labels first, second, third and fourth. For example, the third and fourth data packets, times, and timestamps may precede the first and/or second data packets, times, and timestamps; the third data packet, time, and timestamp may precede the first data packet, time, and timestamp, and the fourth data packet, time, and timestamp may follow the first data packet, time, and timestamp; the third and fourth data packets, times, and timestamps may follow the first data packet, time, and timestamp and precede the second data packet, time, and timestamp; the third data packet, time, and timestamp may precede the second data packet, time, and timestamp, and the fourth data packet, time, and timestamp may follow the second data packet, time, and timestamp; the third and fourth data packets, times, and timestamps may follow the first and second data packets, times, and timestamps; etc. Moreover, each timestamp may be a hardware timestamp (e.g., an Ethernet timestamp) that is generated by the respective NID.

FIGS. 4A and 4B provide a flow chart illustrating operation of LIDAR system 300 of FIG. 3 according to some embodiments of inventive concepts. At block 401, host computer 310 generates a first data packet to initiate transmission of a primary light signal to remote target 351 (e.g., NID 315a of host computer 310 generates the first data packet). At block 405, host computer 310 generates a first timestamp associated with the first data packet and associated with time T₁ when the first data packet is generated/transmitted (e.g., NID 315a generates the first timestamp based on clock 317a and oscillator 318a), and host computer 310 stores the first timestamp (e.g., processor 311 stores the first timestamp in memory 313). At block 409, host computer 320 transmits the first data packet to first optical transceiver 320a of optical system 319 (e.g., NID 315a transmits the first data packet to processor 321a of optical transceiver 320a).

At block 411, optical transceiver 320a receives the first data packet from host computer 310 (e.g., processor 321a of optical transceiver 320a receives the first data packet from NID 315a). At block 415, optical transceiver 320a transmits the primary light signal responsive to the first data packet (e.g., optical transmitter 323a transmits the primary light signal). As discussed above, the primary light signal may be a primary laser signal. At block 419, optical assembly 341 directs the primary light signal from optical transceiver 320a to remote target 351 (also referred to as steering the primary light signal), and at block 425, optical assembly 141 directs the reflected light signal (i.e., a reflection of the primary light signal from remote target 351) to optical transceiver 320b (e.g., to optical receiver 325b).

At block 429, optical transceiver 320b generates a second data packet responsive to receiving the reflected light signal (e.g., processor 321b generates the second data packet) where the second data packet indicates reception of the reflected light signal. At block 435, optical transceiver 320b transmits the second data packet to host computer 310 (e.g., processor 321b transmits the second data packet to NID 315b).

At block 439, host computer 310 receives the second data packet indicating reception of the reflected light signal (e.g., NID 315b receives the second data packet), and at block 441, host computer 310 generates a second timestamp associated with the second data packet and associated with time T₂ when the second data packet is generated/received (e.g., NID 315b generates the second timestamp based on clock 317b and oscillator 318b), and host computer 310 stores the second timestamp (e.g., processor 311 stores the second timestamp in memory 313).

At block 451, host computer 310 generates a third data packet to initiate transmission of a reference signal over reference signal path 331 (e.g., NID 315b generates the third data packet). At block 455, host computer 310 generates a third timestamp associated with the third data packet and associated with the time T₃ when the third data packet is generated/transmitted (e.g., NID 315b generates the third data packet based on clock 317b and oscillator 318b), and host computer 310 saves the third timestamp (e.g., processor 311 saves the third timestamp in memory 313). At block 459, host computer 310 transmits the third data packet to optical transceiver 320b (e.g., NID 315b transmits the third data packet to processor 321b of optical transceiver 320b).

At block 461, optical transceiver 320b receives the third data packet (e.g., processor 321b of optical transceiver 320b receives the third data packet), and at block 465, optical transceiver 320b transmits the reference signal over reference signal path 331 having the fixed/known delay T_{rf} in response to receiving the third data packet (e.g., optical transmitter 323b of optical transceiver 320b transmits the reference signal responsive to receipt of the third data packet at processor 321b).

At block 471, the reference signal is received at optical transceiver 320a over reference signal path 331 (e.g., the reference signal is receive by optical receiver 325a of optical transceiver 320a). At block 479, optical transceiver 320a generates a fourth data packet responsive to receiving the reference signal over the reference signal path (e.g., processor 321a generates the fourth data packet), where the fourth data block indicates reception of the reference signal over reference signal path 331. At block 485, optical transceiver 320a transmits the fourth data packet to host computer 310 (e.g., processor 321a of optical transceiver 320a transmits the fourth data packet to NID 315a).

At block 489, host computer 310 receives the fourth data packet (e.g., NID 315a receives the fourth data packet). At block 491, host computer 310 generates a fourth time stamp associated with the fourth data packet and associated with time T₄ when the fourth data packet is generated/received (e.g., NID 315a generates the fourth time stamp based on clock 317a and oscillator 318a). At block 495, host computer 310 determines a distance to remote target 351 based on the first, second, third, and fourth timestamps (e.g., processor 311 determines the distance based on the timestamps stored in memory 313) and based on the fixed/known delay T_{rf} through reference signal path.

As discussed above, host computer 310 may calculate the distance to remote target 351 using the following formulas:

$${T}_{of} = [ {T}_{2} - {T}_{1} ] - [ ( {T}_{4} - {T}_{3} ) - {T}_{rf} ] ; or \qquad ( Equation 4 )$$

$$D = c ( {T}_{of )} / 2. \qquad ( Equation 5 )$$

According to some embodiments of FIGS. 4A and 4B, the first and fourth timestamps may be generated by NID 315a using clock 317a and oscillator 318a, and the second and third timestamps may be generated by NID 315b using clock 317b and oscillator 318. Moreover, the clocks 317a and 317b may be independent of each other in that they operate based on different oscillators. In such embodiments, the first and second timestamps are respectively generated using first and second clocks that are independent of each other and the third and fourth timestamps are respectively generated using the second and first clocks that are independent of each other.

According to some other embodiments, the reference signal may be transmitted in the opposite direction from optical transceiver 320a through reference signal path 331 to optical transceiver 320b. In such embodiments, first and third data packets and first and third timestamps may be generated/transmitted by/using NID 315a, clock 317a, and oscillator 318a; and second and fourth data packets and second and fourth timestamps may be generated/transmitted by/using NID 315b, clock 317b, and oscillator 318b. In such embodiments, the first and second timestamps are respectively generated using the first and second clocks that are independent of each other and the third and fourth timestamps are respectively generated using the first and second clocks that are independent of each other.

Moreover, each of the first, second, third, and fourth data packets may be an Ethernet data packet, and each of the first, second, third, and fourth timestamps may be an Ethernet timestamp. In addition, NIDs 315a and 315b may operate according to the Ethernet communication protocol.

In embodiments of LIDAR system 300 discussed above with respect to FIGS. 3 and 4A-B, arrival and/or departure times of data packets (e.g., times T₁, T₂, T₃, and T₄ based on respective timestamps) may be used to measure distances. By using the reference signal path 331, timestamps for the reference signal path (associated with times T₃ and T₄) may be used to support cooperative measurements of arrival and departure times and cooperative compensation of distortions due to arrival and departure timing measurements that result from signal processing/transmission delays and/or oscillator inaccuracies. Moreover, time and frequency transfer (TFT) techniques disclosed herein may provide synchronizations between the different clocks/oscillators of NIDs 315a and 315b. According to some other embodiments, timestamps may be generated based on reception of data packets at and/or transmission of data packets from optical transceivers 320a and/or 320b.

Accordingly, timestamp based approaches disclosed herein (e.g., based on the Ethernet communications protocol) may be used to provide reduced cost LIDAR systems, and such LIDAR systems may be used, for example, to control autonomous systems (e.g., autonomous driving) and/or to provide remote sensing. According to some embodiments disclosed herein, custom electro-optical LIDAR components may be replaced with relatively low cost network based components such as Ethernet based components that provide distance measurements at the Ethernet layer.

The terminology used herein is for the purpose of describing particular embodiments only and is not intended to be limiting of inventive concepts. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. The term “and/or” includes any and all combinations of one or more of the associated listed items.

It will be understood that, although the terms first, second, third, etc. may be used herein to describe various elements, these elements should not be limited by these terms. These terms are only used to distinguish one element from another element. Thus, a first element discussed herein could be termed a second element without departing from the scope of the present inventive concepts.

It will also be understood that when an element is referred to as being “coupled” to/with or “connected” to/with another element, it can be directly coupled or connected to/with the other element, or intervening elements may be present. In contrast, when an element is referred to as being “directly coupled” to/with or “directly connected” to/with another element, there are no intervening elements present. Similarly, when an operation/element is referred to as being “responsive to” or “in response to” another event/operation/element, it can be directly responsive to or directly in response to the other operation/element or intervening events/operations/elements may be present. In contrast, when an operation/element is referred to as being “directly responsive to” or “directly in response to” another event/operation/element, there are no intervening events/operations/elements present.

Unless otherwise defined, all terms (including technical and scientific terms) used herein have the same meaning as commonly understood by one of ordinary skill in the art to which the inventive concepts herein belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The operations of any methods disclosed herein do not have to be performed in the exact order disclosed, unless an operation is explicitly described as following or preceding another operation and/or where it is implicit that an operation must follow or precede another operation. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description herein.

While inventive concepts have been particularly shown and described with reference to examples of embodiments thereof, it will be understood that various changes in form and details may be made therein without departing from the spirit of the following claims.

1. A method of performing light detection and ranging (LIDAR), the method comprising:
generating, transmitting, and/or receiving a first data packet to initiate transmission of a primary light signal to a remote target;
generating a first timestamp associated with the first data packet;
generating, receiving, and/or transmitting a second data packet indicating reception of a reflected light signal, wherein the reflected light signal is a reflection of the primary light signal from the remote target;
generating a second timestamp associated with the second data packet; and
determining a distance to the remote target based on the first and second timestamps.

2. The method of claim 1, further comprising:
generating, transmitting, and/or receiving a third data packet to initiate transmission of a reference signal over a reference signal path;
generating a third timestamp associated with the third data packet;
generating, receiving, and/or transmitting a fourth data packet indicating reception of the reference signal over the reference signal path; and
generating a fourth timestamp associated with the fourth data packet;
wherein determining the distance comprises determining the distance to the remote target based on the first, second, third, and fourth timestamps.

3. The method of claim 2, further comprising;
transmitting the primary light signal responsive to the first data packet;
receiving the reflected light signal;
transmitting the reference signal over the reference signal path responsive to the third data packet; and
receiving the reference signal over the reference signal path.

4. The method of claim 2, wherein the first timestamp is generated using a first clock, wherein the second timestamp is generated using a second clock, wherein the third timestamp is generated using the second clock, wherein the fourth timestamp is generated using the first clock, and wherein the first and second clocks are independent of each other.

5. The method of claim 4, wherein the first clock operates based on a first oscillator, wherein the second clock operates based on a second oscillator, and wherein the first and second oscillators are different oscillators.

6. The method of claim 2, wherein the distance to the remote target is determined based on a difference between times associated with the second and first timestamps and a difference between times associated with the fourth and third timestamps.

7. The method of claim 2, wherein determining the distance to the remote target is further based on a delay of the reference signal path, wherein the delay of the reference signal path is determined prior to generating the third data packet.

8. The method of claim 2, wherein the first, second, third, and fourth data packets comprise first, second, third, and fourth Ethernet data packets.

9. The method of claim 2:
wherein the first and second timestamps are generated respectively using first and second clocks that are independent of each other and the third and fourth timestamps are generated respectively using the second and first clocks; or
wherein the first and second timestamps are generated respectively using the first and second clocks that are independent of each other and the third and fourth timestamps are generated respectively using the first and second clocks.

10. (canceled)

11. (canceled)

12. (canceled)

13. A light detection and ranging (LIDAR) system comprising:
an optical system configured to transmit a primary light signal to a remote target in response to a first data packet, to receive a reflected light signal, and to generate a second data packet in response to receiving the reflected light signal, wherein the reflected light signal is a reflection of the primary light signal from the remote target; and
a host computer coupled with the optical system, wherein the host computer is configured to generate the first data packet to initiate transmission of the primary light signal to the remote target, to generate a first timestamp associated with the first data packet, to receive the second data packet from the optical system indicating reception of the reflected light signal from the remote target, to generate a second timestamp associated with the second data packet, and to determine a distance to the remote target based on the first and second timestamps.

14. The LIDAR system of claim 13,
wherein the optical system further defines a reference signal path, wherein the optical system is further configured to transmit a reference signal over the reference signal path in response to a third data packet, to receive the reference signal over the reference signal path, and to generate a fourth data packet responsive to receiving the reference signal over the reference signal path; and
wherein the host computer is configured to generate the third data packet to initiate transmission of the reference signal over the reference signal path, to generate a third timestamp associated with the third data packet, to receive the fourth data packet indicating reception of the reference signal over the reference signal path, to generate a fourth timestamp associated with the fourth data packet, and to determine the distance to the remote target based on the first, second, third, and fourth timestamps.

15. The LIDAR system of claim 14, wherein the host computer comprises first and second clocks that are independent of each other, wherein the host computer is configured to generate the first timestamp based on the first clock, to generate the second timestamp based on the second clock, to generate the third timestamp based on the second clock, and to generate the fourth timestamp based on the first clock.

16. The LIDAR system of claim 15, wherein the first clock operates based on a first oscillator, wherein the second clock operates based on a second oscillator, and wherein the first and second oscillators are different oscillators.

17. The LIDAR system of claim 14, wherein the host computer is configured to determine the distance to the remote target based on a difference between times associated with the second and first timestamps and a difference between times associated with the fourth and third timestamps.

18. The LIDAR system of claim 14, wherein the host computer is configured to determine the distance to the remote target based on the first, second, third, and fourth timestamps, and based on a delay of the reference signal path, wherein the delay of the reference signal path is determined prior to transmitting the third data packet.

19. The LIDAR system of claim 18, wherein the first, second, third, and fourth data packets comprise first, second, third, and fourth Ethernet data packets.

20. The LIDAR system of claim 18, wherein the host computer comprises a first network interface device having a first clock and a second network interface device having a second clock, wherein the first and second clocks operate independently, wherein the first network interface device is configured to transmit the first data packet and to generate the first timestamp based on the first clock, wherein the second network interface device is configured to receive the second data packet and to generate the second timestamp based on the second clock, wherein the second network interface device is configured to transmit the third data packet and to generate the third timestamp based on the second clock, and wherein the first network interface device is configured to receive the fourth data packet and to generate the fourth timestamp based on the first clock.

21. The LIDAR system of claim 14,
wherein the optical system comprises the reference signal path, a first optical transceiver including a first optical transmitter and a first optical receiver, a second optical transceiver including a second optical transmitter and a second optical receiver, and an optical assembly,
wherein the reference signal comprises a reference light signal,
wherein the reference signal path comprises an optical reference signal path,
wherein the first optical transmitter is configured to transmit the primary light signal responsive to the first data packet being received at the first optical transceiver,
wherein the optical assembly is configured to direct the primary light signal to the remote target,
wherein the first optical receiver is configured to receive the reference light signal over the reference signal path,
wherein the first optical transceiver is configured to generate the fourth data packet responsive to receiving the reference light signal at the first optical receiver,
wherein the second optical transmitter is configured to transmit the reference light signal over the optical reference signal path responsive to the third data packet being received at the second optical transceiver,
wherein the optical assembly is configured to direct the reflected light signal to the second optical receiver,
wherein the second optical receiver is configured to receive the reflected light signal, and
wherein the second optical transceiver is configured to generate the second data packet responsive to receiving the reflected light signal at the second optical receiver.

22. The LIDAR system of claim 21,
wherein the host computer comprises a first network interface device including a first clock and a second network interface device including a second clock,
wherein the first and second clocks operate independently,
wherein the host computer is configured to transmit the first data packet from the first network interface device to the first optical transceiver,
wherein the first network interface device is configured to generate the first timestamp based on the first clock,
wherein the host computer is configured to receive the second data packet at the second network interface device from the second optical transceiver,
wherein the second network interface device is configured to generate the second timestamp based on the second clock,
wherein the host computer is configured to transmit the third data packet from the second network interface device to the second optical transceiver,
wherein the second network interface device is configured to generate the third timestamp based on the second clock,
wherein the host computer is configured to receive the fourth data packet at the first network interface device from the first optical transceiver, and
wherein the first network interface device is configured to generate the fourth timestamp based on the first clock.

23. (canceled)

24. (canceled)

25. (canceled)

26. A method of performing light detection and ranging (LIDAR), the method comprising:
generating a first data packet to initiate transmission of a primary light signal to a remote target;
generating a first timestamp associated with the first data packet;
transmitting the primary light signal to the remote target responsive to the first data packet;
receiving a reflected light signal that is a reflection of the primary light signal from the remote target;
generating a second data packet responsive to receiving the reflected light signal;
generating a second timestamp associated with the second data packet;
generating a third data packet to initiate transmission of a reference signal over a reference signal path;
generating a third timestamp associated with the third data packet;
transmitting a reference signal over a reference signal path responsive to the third data packet;
receiving the reference signal over the reference signal path;
generating a fourth data packet responsive to receiving the reference signal over the reference signal path;
generating a fourth timestamp associated with the fourth data packet; and
determining a distance to the remote target based on the first, second, third, and fourth timestamps.

27. (canceled)
